(19) United States
(12) Patent Application Publication
(10) Pub. No.: US 2005/0237886 A1
(43) Pub. Date: Oct. 27, 2005

(54) Information carrier provided with a transitional region between the clambing area and the information area

(75) Inventor: Josephus Arnoldus Henricus Maria Kahlman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/520,195

(22) PCT Filed: Jun. 27, 2003
(86) PCT No.: PCT/IB03/03000

§ 371 Date: Jan. 4, 2005

(30) Foreign Application Priority Data
Jul. 8, 2002 (EP) 02077712.4

(51) Int. Cl. G11B 23/30

(52) U.S. Cl. 369/52.1

(57) ABSTRACT

An information carrier on which a clamping area (12) and an information area (13) are defined, has an integrated circuit and an antenna (22) which is coupled to the integrated circuit. The antenna is positioned in the region between the information area and the clamping area. The disc also has a metal layer and a polycarbonate layer in which the information is stored. To improve the communication between the integrated circuit on the disc and the apparatus, the information carrier has no metal layer in the region of the antenna, i.e. the region between the information area and the clamping area. In this way, there is no possibility or eddy currents to occur.

The invention relates to an information carrier on which a clamping area and an information area are defined, said information carrier being provided with a metal layer, an integrated circuit, and an antenna connected to the integrated circuit, which antenna is positioned in a region between the clamping area and the information area of the information carrier.

The invention also relates to a system comprising an information carrier on which a clamping area and an information area are defined, said information carrier being provided with a metal layer, an integrated circuit, and an antenna connected to the integrated circuit, which antenna is positioned in a region between the clamping area and the information area of the information carrier; and comprising a device provided with communication means for establishing an electromagnetic coupling with the antenna on the information carrier.

The invention further relates to a method of manufacturing an information carrier, comprising the following steps:
manufacturing a synthetic resin molded product for the information carrier;
defining an information area and a clamping area; and
providing at least one metal layer on the synthetic resin molded product.

Many information carriers are on the market nowadays on which data can be distributed. These information carriers are often optical discs such as CDs, CD-ROMs, or DVD-ROMs nowadays. Such discs may be used for storing and filing comparatively large quantities of data in a simple manner, for example digital photos, films, and music albums. A sufficient amount of equipment is available on the consumer market by this time enabling individuals to create their own CD compilations, but also to make copies of existing CD, CD-ROM, or DVD-ROM discs. The data, the digital file, on the CDs is often protected by copyright. Royalties are normally paid to the owner of the digital work stored on the relevant information carrier for each CD that is sold. The illegal copying and distributing of these digital works has the result that, for example, artists, producers, and software developers are bereft of much income. Digital media publishers-raise the alarm for counteracting the illegal copying of these items protected by copyright.

One of the systems devised as a solution to the above copying problem is the encoding of the digital work by means of coding keys and the addition of digital user rights. The digital user rights, for example, impose restrictions on the maximum number of times a CD can be copied, or the maximum number of times a CD can be played back. It is not possible to reproduce the digital work on an appliance suitable for this without the correct user lights and decoding keys.

The decoding keys and the user rights are supplied along with the digital work during purchase. These keys and user rights may be stored in the wobble of the information carrier, so that copying of the key is not possible. It is also possible to hide these keys in so-termed hidden channels of the information carrier.

Another possibility that is increasingly taken into consideration is the storage of the decoding keys and the user rights for the digital work in a separate memory which is fastened on the information carrier. This separate memory is, for example, an integrated circuit which can communicate via communication means with the player of the information carrier so as to transmit the correct decoding key. The information in the integrated circuit is specific to the digital work stored on the information carrier.

Such a system, in which an integrated circuit or chip is provided on an information carrier with the object of storing additional information, such as user rights, separately from the actual information, is known from U.S. Pat. No. 6,373,799. This chip is provided with electromagnetic receiver means for obtaining the energy required for the operation of the chip. Furthermore, electromagnetic transmitter and receiver means are present on the chip of the information carrier so as to render possible a communication between the chip and the playback device. The playback device accordingly also has an integrated circuit (read-out IC) with an antenna which renders this communication possible.

A disadvantage of the known information carrier is that the communication between the chip and the read-out IC present in the playback device is not optimal.

It is an object of the invention to provide an information carrier which promotes a good communication between the chip and the read-out IC.

This object is achieved in that the region between the clamping area and the information area is at least partly free from the metal layer.

The invention is based on the recognition that the information carrier, which is provided with a metal layer, rotates in an electromagnetic field that varies in time, so that so-termed eddy currents arise in the metal layer. A current-conducting antenna generates a magnetic field. The change in magnetic flux generates an electric field in accordance with Faraday's law. This electric field is also induced in the metal layer of the information carrier. This results in the movement of free charge carriers in the metal in the direction of the electric field. Circular currents are generated in this manner, the eddy currents. Said currents create a magnetic field in opposite direction (Lenz's law), with the result that the total magnetic flux decreases significantly.

These eddy currents thus adversely affect the communication between the chip and the read-out IC. This can be prevented in that the metal layer is removed from the information carrier at the level of the antenna coupled to the chip, so that no eddy currents can arise.

An embodiment of the information carrier according to the invention is characterized in that the metal layer in the region between the clamping area and the information area is provided with at least one recess over the entire width of said region.

If visual information is provided, for example, such as a manufacturer's mark, it is also possible to provide a certain pattern in this metal layer, or to provide the metal with recesses such that the path in which eddy currents may arise is interrupted.

The system is characterized in that the region between the clamping area and the information area is at least partly free from the metal layer.

The method is characterized in that the method further comprises the following step: applying an inner mask extending up to the information area, such that the region between the clamping area and the information area remains at least partly free from a metal layer.

These and other aspects of the information carrier, the system, and the method according to the invention will be explained in more detail below with reference to drawings, in which:

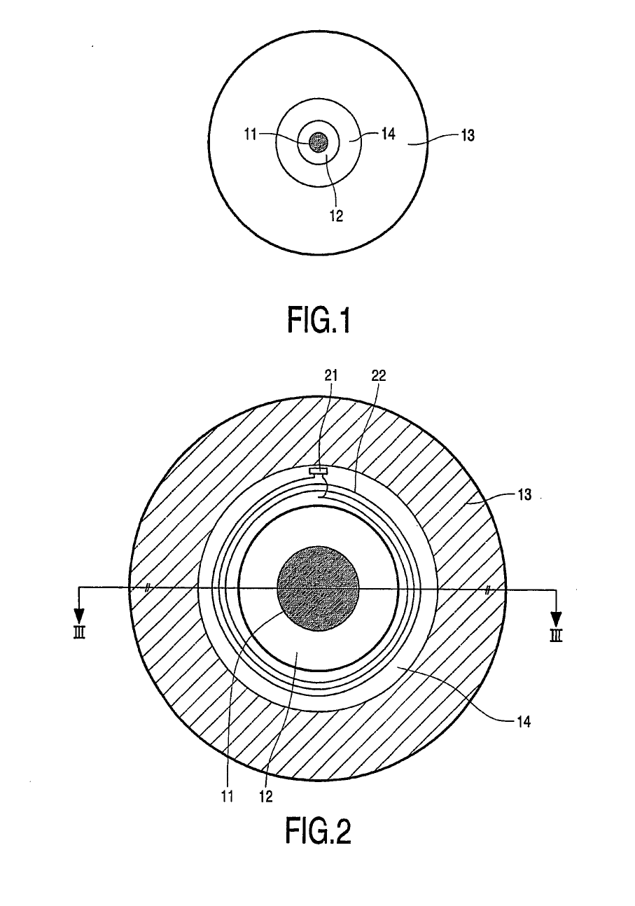

FIG. 1 is a diagrammatic plan view of the information carrier,

FIG. 2 is also a diagrammatic plan view of a first embodiment of the information carrier,

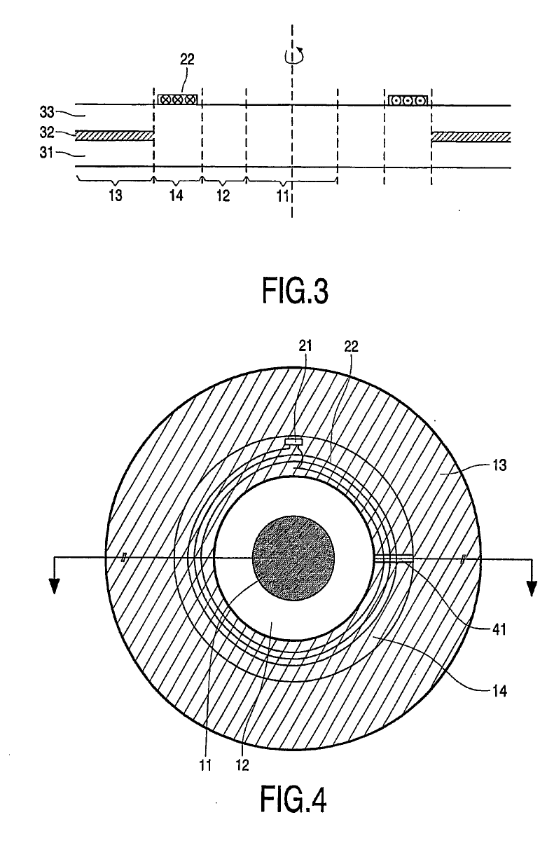

FIG. 3 is a diagrammatic cross-sectional view of a first embodiment of the information carrier taken on the line III-III in FIG. 1,

FIG. 4 is a diagrammatic plan view of a second embodiment of the information carrier,

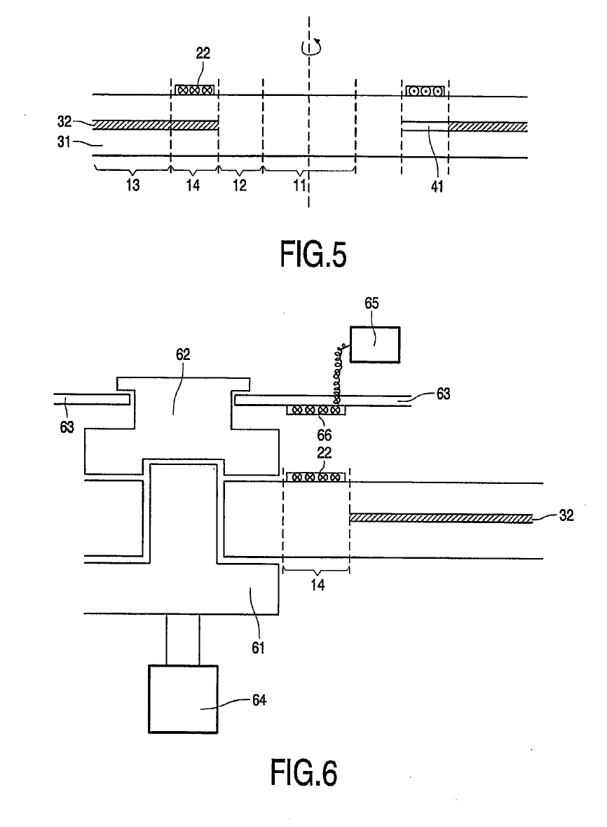

FIG. 5 is a diagrammatic cross-sectional view of the second embodiment of the information carrier taken on the line V-V in FIG. 4,

FIG. 6 is a diagrammatic cross-sectional view of an embodiment of the system comprising an information carrier and an appliance,

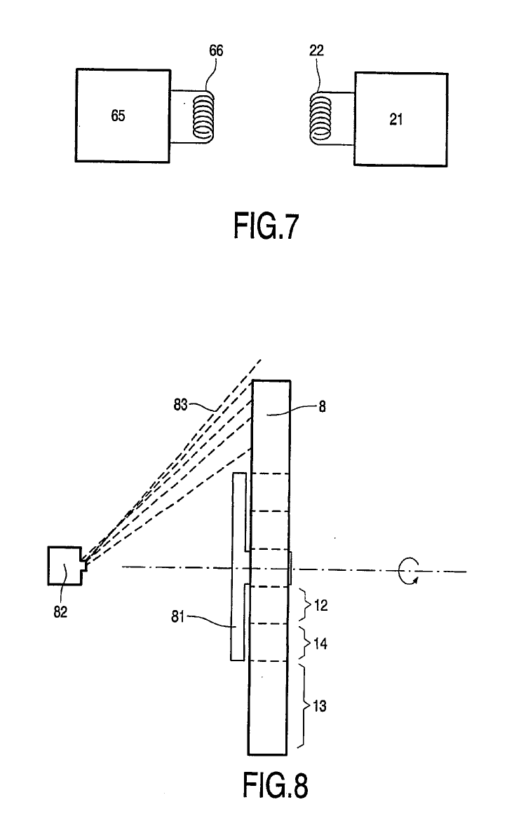

FIG. 7 is a circuit diagram of the communication means of the appliance and of the chip and antenna on the information carrier, and

FIG. 8 is a diagrammatic side elevation showing a step in the method.

The Figures are diagrammatic and not drawn to scale, and corresponding components have been given the same reference numerals. Furthermore, the mutual dimensional ratios of the components have not been necessarily exactly depicted in the Figures for reasons of clarity, where applicable. It will be clear to those skilled in the art that alternative but equivalent embodiments of the invention are possible without departing from the essence of the invention, and that the scope of the invention is limited by the claims only. Thus the embodiments described below relate to an information carrier with an integrated circuit, such as a DVD. It will be obvious that the principles of the invention may be equally well applied to other rotating information carriers such as CD-R, CD, DVD+RW, CD-I, and other members of the family of optical information carriers. It will also be obvious to those skilled in the art that the description given below of embodiments of a playback appliance is also applicable to a recording appliance for writing on the optical storage unit.

FIG. 1 shows the information carrier according to the invention, which is a disc with an optically readable storage unit in this example. The information carrier 1 is provided with a center hole 11 situated in the center of the disc. Several areas are defined on the information carrier 1, furthermore, which areas may each have, for example, different physical properties. The disc comprises a clamping area 12 which is used for clamping the disc between two bodies. This clamping renders it possible for the disc to move and rotate about the center of the disc in a contactless manner. This will be described in more detail below when the system is discussed. Furthermore, an information area 13 is defined on the disc, where the optically readable storage unit is present. This storage unit comprises a track which is arranged in a spiraling or concentric pattern. It is possible to read the track on the information carrier by means of a read head known to those skilled in the art. The read head comprises inter alia an optical system for focusing a light beam, for example generated by a laser diode. The optical storage unit is built up from several layers, among them a polycarbonate layer and a metal layer. A transitional region 14 is present between the clamping area 12 and the information area 13. The transitional region 14 is also constructed with the polycarbonate layer and the metal layer in the prior art. The transitional region 14 is denoted the CiD region hereinafter.

The optical information carrier 1 further comprises an integrated circuit 21 and an antenna 22 which is connected to the integrated circuit (denoted chip hereinafter) 21. An embodiment of the information carrier with the chip and the antenna shown in the CiD region can be seen in FIG. 2. The antenna is preferably a coiled antenna. The antenna is always located in the CiD region. There are no limitations as to the positioning of the chip, for example, it is possible to position the chip in the information area, but the CiD region is preferred. The chip is, for example, a MiFare RFID chip manufactured by Philips Electronics N.V. and is also described in the RFID HANDBOOK, p. 282 by Klaus Finkenzeller, published by John Wiley & Sons.

The chip provides the possibility of storing information. This information may be, for example, a decoding key for decoding the digital work stored in coded form on the information carrier. The illegal copying and distribution of the digital work on the information carrier is rendered more difficult through the provision of the decoding keys in a separate memory, and not on the information carrier itself. Another example of the use of the storage capacity in the chip is the storage of a table of contents. This table of contents may comprise all titles and performing artists of musical numbers stored on the information carrier in the case in which the digital work comprises, for example, a plurality of music albums. This information in the chip may then be read out, for example, and displayed on a screen.

The chip and the antenna are capable of achieving an electromagnetic coupling to another antenna connected to a read-out IC in a playback appliance, as will be explained in more detail in the discussion of the system.

To promote the communication between the chip on the disc and the read-out IC, no metal layer is present in the CiD region. The metal layer is shown hatched in the plan view of an embodiment of the information carrier in FIG. 1. No eddy currents interfering with the electromagnetic coupling will arise because no metal layer is present adjacent the antenna.

FIG. 3 is a diagrammatic cross-sectional view of the first embodiment of the information carrier taken on the line III-III in FIG. 1. The optical information carrier in this embodiment is in the form of a DVD. As is known to those skilled in the art, the layered structure of this disc is such that pits and lands are formed in the polycarbonate layer 31. The binary data are encoded in these pits and lands. A reflecting metal layer 32 is laid over this polycarbonate layer. This combination of layers has a thickness of 0.6 mm. An additional polycarbonate layer 33 is provided on top of these layers for obtaining an additional strength and protection.

The antenna 22 is located in the CiD region 14 and is provided at the upper side of the disc. Although this embodiment is preferred because of the comparatively simple adaptation of the production process of optical information carriers, it is alternatively possible to provide the antenna between the layers of the disc. The antenna is then shaped in that a continuous metal layer is sputtered, from which the antenna wires are cut out by means of laser technology. The provision of the antenna on top of the disc may take place, for example, by means of a sticker. Conductive current wires are positioned in a coiled pattern on an adhesive layer and then fastened to the disc. These conductive wires form the antenna and are directly connected to the chip on the information carrier. As will be apparent to those skilled in the art, the antenna may alternatively be fastened to the lower side of the information carrier, i.e. the same side from which the optical storage unit is also read.

The metal layer 32 is present in the information area and not in the CiD region. This promotes the communication between the chip and the read-out IC. Since no metal layer is situated adjacent the antenna, no eddy currents will arise which interfere with the electromagnetic coupling.

As those skilled in the art will understand, the same principle may be applied to other optical information carrier families such as the CD family and the DVR family, in which the metal layer is at different levels in the disc.

FIG. 4 is a diagrammatic plan view of a second embodiment of the information carrier. In this embodiment, the reflecting metal layer is present in the CiD region, but it has an interruption 41 over the entire length of the CiD region. There is no closed circuit anymore in the metal layer. The occurrence of eddy currents in the metal layer owing to a changing magnetic field comprising the metal layer is accordingly made impossible.

FIG. 5 is a diagrammatic cross-sectional view of the second embodiment of the information carrier taken on the line V-V in FIG. 4. The antenna 22 lies on top of the information carrier in the CiD region 14. It is apparent from the Figure that the metal layer 32 is interrupted in the CiD region and that no metal is present over the full length of this region. The width of the interruption 41 in the metal layer is not essential. The path along which the eddy currents could arise in the present situation has been broken, so that the occurrence of eddy currents in the CiD region is excluded in this embodiment of the invention.

FIG. 6 is a diagrammatic dross-sectional view of an embodiment of a system comprising the information carrier and an appliance. The appliance comprises inter alia reading means (not shown), for example a read head for reading out information from the optical storage unit. The appliance further comprises a carrier body 61 on which the information carrier 1 can be laid. A pressure body 62 is subsequently fastened on the information carrier 1 so as to clamp the information carrier. The carrier body has a shaft that is passed through the center hole of the information carrier 1. The pressure body is fastened to the shaft of the carrier body. In this configuration, therefore, the information carrier is between the carrier body 61 and the pressure body 62. The information carrier makes contact with the carrier body and the pressure body in the clamping area of the information carrier. The pressure body is positioned in a bridge 63 in which it can move freely in the direction of the carrier body and can rotate about the axis of the carrier body. Furthermore, the appliance comprises an electric motor 64 which is fastened to the carrier body and is arranged such that the information carrier 1 rotates in the appliance, as is known to those skilled in the art.

The appliance further comprises communication means for establishing an electromagnetic coupling with an information carrier 1 provided with an antenna and a chip as described above and shown in FIG. 2. The communication means of the appliance comprise a read-out IC 65 and another antenna 66. The read-out IC is, for example, a MiFare RFID ReaderIC manufactured by Philips Electronics N.V. and is also described in the cited RFID HANDBOOK by Klaus Finkenzeller. This ReaderIC operates at 13.56 MHz, which corresponds to a wavelength of the electromagnetic waves of approximately 22 m. Since the distance between the two antennas is many times smaller than 22 m, all may be regarded as magnetic flux. The antenna 66 of the communication means in the appliance is connected to the ReaderIC and has a coil-type or concentric character.

The antenna 66 of the communication means of the appliance is preferably arranged perpendicularly above the antenna on the information carrier so as to obtain an optimum coupling. This coupling must be achieved inter alia when the information carrier is in the appliance and the optical storage unit of the information carrier is being read out. The antenna in the appliance may be fastened, for example, to the bridge 63 perpendicularly above the antenna on the information carrier as shown in FIG. 6. It will be clear to those skilled in the art that alternative embodiments are also possible.

The metal layer 32 is present in the information area and not in the CiD region. This benefits the communication between the chip and the read-out IC. Since no metal layer is present adjacent the antenna, no eddy currents will arise which interfere with the electromagnetic coupling.

FIG. 7 is a circuit diagram of the communication means of the appliance and the chip and antenna on the information carrier. As is known to those skilled in the art, a current changing in time through a first coil will generate a magnetic flux which also changes in time. The inductance law states that a voltage will be induced in the first coil, but also in a second coil if the latter comprises a portion of the generated magnetic flux.

The changing magnetic flux in the antenna 66 connected to the read-out IC 65 induces a voltage in the antenna 22 connected to the chip 21 on the information carrier 1 owing to the mutual induction. Communication can thus take place between the chip on the information carrier and the read-out IC in the appliance by means of electromagnetic coupling.

An adaptation in the manufacturing process is to take place if the information carrier in one of the embodiments of the invention is to be manufactured. A synthetic resin molded product is manufactured in the method of manufacturing optical information carriers in a manner known to those skilled in the art. This synthetic resin molded product comprises pits and lands in which the information is stored. A metal layer having reflective properties is provided on this molded product. The provision of the metal layer is a process known to those skilled in the art. The synthetic resin molded product is provided with metal by a sputtering machine 82. Said metal 83 is sputtered on the molded product, as is shown in FIG. 8.

If certain regions on the synthetic resin molded product are not to be provided with this metal layer, for example, a mask is provided over the molded product. Different regions of the information carrier may be defined in this manner in that different physical properties are given thereto.

For manufacturing an information carrier according to the invention, an inner mask 81 extending up to the information area 13 is used such that the region 14 between the clamping area 12 and the information area 13 remains at least partly free from any metal layer 83, 32.

Instead of providing a mask, it is alternatively possible to control the sputtering machine 82 such that the maximum and minimum sputtering angles are set. It is possible in this manner also to provide specific areas with a metal layer.

1. An information carrier on which a clamping area and an information area are defined, said information carrier being provided with a metal layer, an integrated circuit, and an antenna connected to the integrated circuit, which antenna is positioned in a region between the clamping area and the information area of the information carrier, characterized in that the region between the clamping area and the information area is at least partly free from the metal layer.

2. An information carrier 1 as claimed in claim 2, characterized in that the metal layer in the region between the clamping area and the information area is provided with at least one recess over the entire width of said region.

3. A system comprising an information carrier on which a clamping area and an information area are defined, said information carrier being provided with a metal layer, an integrated circuit, and an antenna connected to the integrated circuit, which antenna is positioned in a region between the clamping area and the information area of the information carrier; and comprising a device provided with communication means for establishing an electromagnetic coupling with the antenna on the information carrier, characterized in that the region between the clamping area and the information area is at least partly free from the metal layer.

4. A method of manufacturing an information carrier, comprising the following steps:
manufacturing a synthetic resin molded product for the information carrier;
defining an information area and a clamping area; and
a providing at least one metal layer on the synthetic resin molded product, characterized in that the method further comprises the following step:
applying an inner mask extending up to the information area, such that the region between the clamping area and the information area remains at least partly free from a metal layer.
